(19) United States
(12) Patent Application Publication
(10) Pub. No.: US 2025/0303385 A1
(43) Pub. Date: Oct. 2, 2025

(54) OPTICAL FIBER REACTOR FOR TREATMENT OF GAS PHASE CONTAMINANTS

(71) Applicants: Pierre Herckes, Gilbert, AZ (US); Paul K. Westerhoff, Scottsdale, AZ (US); Matthew Fraser, Phoenix, AZ (US)

(72) Inventors: Pierre Herckes, Gilbert, AZ (US); Paul K. Westerhoff, Scottsdale, AZ (US); Matthew Fraser, Phoenix, AZ (US)

(21) Appl. No.: 19/091,384

(22) Filed: Mar. 26, 2025

Related U.S. Application Data
(60) Provisional application No. 63/569,889, filed on Mar. 26, 2024.

(51) Int. Cl. B01J 19/12; B01D 53/00; B01D 53/86

(52) U.S. Cl. CPC B01J 19/123; B01D 53/007; B01D 53/8631; B01D 2255/20707; B01D 2255/802; B01D 2257/402; B01D 2257/404; B01D 2259/804; B01J 2219/024; B01J 2219/1203; B01J 2219/1943

(57) ABSTRACT

An optical fiber reactor includes a reaction chamber defining an inlet at a first end of the reaction chamber and an outlet at a second end of the reaction chamber, a multiplicity of side-emitting optical fibers extending from the first end toward the second end, and a light source optically coupled to the optical fibers and configured to irradiate the photocatalyst on the multiplicity of side-emitting optical fibers from an interior of each of the optical fibers at a selected wavelength. The inlet is configured to receive an input gas including a contaminant and the outlet is configured to allow egress of a treated gas from the reaction chamber. The exterior surface of each optical fiber of the multiplicity of optical fibers is coated with a photocatalyst, which is configured to reduce a concentration of the contaminant in the reaction chamber through photocatalytic oxidation or reduction of the contaminant.

### CROSS-REFERENCE TO RELATED APPLICATION

This application claims the benefit of U.S. Patent Application No. 63/569,889 filed on Mar. 26, 2024, which is incorporated by reference herein in its entirety.

### STATEMENT OF GOVERNMENT SUPPORT

This invention was made with government support under 1449500 awarded by the National Science Foundation. The government has certain rights in the invention.

### TECHNICAL FIELD

This invention relates to photocatalytic optical fiber reactors for treatment of gas phase contaminants (e.g., reduction of nitrogen oxides).

### BACKGROUND

Nitrogen oxides (NOₓ) have been identified as pollutants of concern. Increasingly lower NOₓ emission standards have created an opportunity for further abatement. For example, NOₓ emissions by industry are regulated, and permitting of industrial facilities is often contingent on emissions including NOₓ. While N₂O is not currently a regulated species, it is a greenhouse gas and depletes stratospheric ozone.

### SUMMARY

The present disclosure describes optical fiber reactors for treatment of gas phase contaminants, such as nitrogen oxides from industrial manufacturing facilities. Utilizing a compact design with efficient packing geometry, the side-emitting photocatalyst-coated optical fibers bundled together inside a cylindrical reactor can be used to treat gas phase contaminants when light of a selected wavelength is provided to the optical fibers. In one example, an optical fiber reactor achieves 40% NO removal in a residence time of less than 1 minute. The adaptability and ability for continuous gas treatment make these reactors suitable for the control of point-source nitrogen oxide emissions in industries (e.g., semiconductor manufacturing, a lithography site, or a powerplant).

In a first general aspect, an optical fiber reactor includes a reaction chamber defining an inlet at a first end of the reaction chamber and an outlet at a second end of the reaction chamber, a multiplicity of side-emitting optical fibers extending from the first end of the reaction chamber toward the second end of the reaction chamber, and a light source optically coupled to the multiplicity of side-emitting optical fibers and configured to irradiate the photocatalyst on the multiplicity of side-emitting optical fibers from an interior of each of the optical fibers with light of a selected wavelength. The inlet is configured to receive an input gas including a contaminant. The outlet is configured to allow egress of a treated gas from the reaction chamber. The exterior surface of each optical fiber of the multiplicity of side-emitting optical fibers is coated with a photocatalyst. The photocatalyst is configured to reduce a concentration of the contaminant in the reaction chamber through oxidation or reduction of the contaminant.

Implementations of the first general aspect can include one or more of the following features. In some cases, the reaction chamber is cylindrical. The multiplicity of side-emitting optical fibers can include glass or plastic. The plastic can include polymethyl methacrylate (PMMA) or polyvinylidene fluoride (PVDF). In certain implementations, the multiplicity of side-emitting optical fibers includes 10 to 1000 optical fibers. In one example, the photocatalyst includes TiO₂. The light source can include one or more light-emitting diodes or organic light-emitting diodes. The light source can be configured to emit ultraviolet radiation. The ultraviolet radiation can include UVA, UVC, or both. In some cases, the selected wavelength is 365 nm. The first general aspect can further include a fan coupled to the reaction chamber to cool the multiplicity of side-emitting optical fibers.

In a second general aspect, reducing a concentration of a contaminant in an input gas includes flowing the input gas including the contaminant into a first end of a reaction chamber including a multiplicity of side-emitting optical fibers, irradiating a first end of each of the multiplicity of the side-emitting optical fibers with light, photocatalytically oxidizing or reducing the contaminant, and flowing the treated gas out of a second end the reaction chamber. An exterior surface of each optical fiber of the multiplicity of side-emitting optical fibers is coated with a photocatalyst. Irradiating the first end of each of the multiplicity of the side-emitting optical fibers with light provides the light along a length of an interior of each of the side-emitting optical fibers and exciting the photocatalyst. Photocatalytically oxidizing or reducing the contaminant reduces a concentration of the contaminant in the reaction chamber to yield a treated gas. A concentration of the contaminant in the input gas exceeds a concentration of the contaminant in the treated gas.

Implementations of the second general aspect can include one or more of the following features. In some cases, flowing the input gas into the first end of the reaction chamber includes flowing the input gas along a length of the side-emitting optical fibers from the first end to the second end. The contaminant can include a nitrogen oxide. In certain implementations, the nitrogen oxide includes NO, NO₂, N₂O, or any combination thereof. In one example, the photocatalyst includes TiO₂. The light can include UVA light. A wavelength of the light can be 365 nm. In some cases, flowing the input gas into the first end of the reaction chamber and flowing the treated gas out of the second end of the reaction chamber occurs simultaneously. In one implementation, irradiating the first end of each of the multiplicity of the side-emitting optical fibers occurs continuously.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 shows a diagram of a TiO₂ coated fiber optics reactor.

FIG. 2 shows an experimental setup used for photocatalyst experiments. A gas dilution and mixing system allows for a range of conditions, including dilution mixes of target gases, flow rates of target gases, and concentrations of nitrogen oxides using a range of flow rates on an order of 0.2 to 2 liters per minute (LPM).

FIG. 3 shows representative data for NOₓ reduction only when light was launched into the optical fibers in the reactor.

FIGS. 4A and 4B show results of photocatalyst and light source testing.

### DETAILED DESCRIPTION

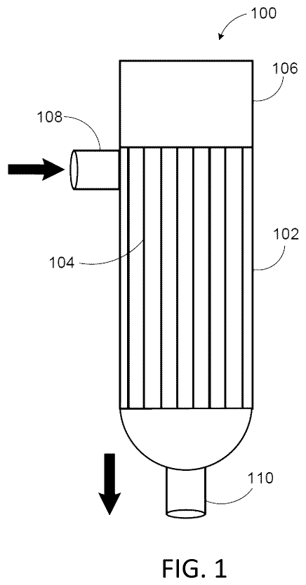

FIG. 1 depicts an optical fiber reactor 100 for treating a contaminated gas to remove or reduce a concentration of contaminants in the gas. The optical fiber reactor 100 includes a reaction chamber 102, a multiplicity of side-emitting optical fibers 104 in the reaction chamber, and a light source 106. The reaction chamber 102 defines an inlet 108 at a first end of the reaction chamber 102. The reaction chamber 102 defines an outlet 110 at a second end of the reaction chamber 102.

The reaction chamber 102 can be made in any suitable shape or size and of any suitable material, such as plastic, metal, glass, and the like. The reaction chamber 102 can be cooled (e.g., with a fan at one end of the reaction chamber). In one example, the reaction chamber 102 is in the shape of a cylinder and is made of plastic (e.g., acrylic).

The multiplicity of optical fibers 104 can include, for example, 10 to 1000, 10 to 500, 10 to 200, or 10 to 100 optical fibers. The optical fibers 104 have an efficient packing geometry and can be spaced apart from one another with one or more spacers. The optical fibers 104 can be made of materials such as plastic (e.g., PMMA/PVDF) or glass, and can be selected to transmit light in a range of wavelengths, such as ultraviolet, visible, infrared, or any combination thereof. An exterior surface of each optical fiber of the multiplicity of side-emitting optical fibers 104 is coated with a photocatalyst. In one example, the photocatalyst coating includes TiO₂. The photocatalyst is configured to reduce a concentration of the contaminant in the reaction chamber 102 through oxidation or reduction of the contaminant. The optical fibers 104 are fabricated or modified for side emission of light, thereby achieving continuous light exposure over the entire catalyst coated exterior surface of each optical fiber of the multiplicity of optical fibers.

The light source 106 is optically coupled to the multiplicity of side-emitting optical fibers 104. The light source 106 irradiates the photocatalyst on the multiplicity of side-emitting optical fibers 104 from an interior of each of the optical fibers. The light source 106 can be selected to provide radiation of a selected wavelength range (e.g., ultraviolet-A (UVA), ultraviolet-C (UVC)) or wavelength (e.g., 365 nm) to the multiplicity of optical fibers 104. The wavelength or wavelength range is selected based on the photocatalyst in the coating. In one example, a wavelength of 365 nm is selected when the photocatalyst is TiO₂. In some examples, the light source 106 is a light emitting diode (LED) or a multiplicity of LEDs. In certain implementations, the light source 106 is an organic light emitting diode (OLED) or a multiplicity of OLEDs.

The optical fiber reactor 100 allows for continuous gas flow through the reaction chamber. The inlet 108 is configured to receive an input gas including a contaminant. The outlet 110 is configured to allow egress of a treated gas from the reaction chamber 102. The multiplicity of side-emitting optical fibers 104 extends from the first end of the reaction chamber 102 toward the second end of the reaction chamber 102. The input gas flows through the inlet 108 and in contact with an exterior surface of the multiplicity of optical fibers 104. The gas is decontaminated by oxidation or reduction of the contaminants in the optical fiber reactor 100. The treated gas exits through the outlet 110 at the second end of the reaction chamber 102. When the input gas includes nitrogen oxides (NOₓ (which includes NO and NO₂), N₂O, or any combination thereof), these nitrogen oxides are reduced to yield N₂, oxidized to yield NO₃⁻, or both, which exit with the treated gas through the outlet 110. A concentration of the contaminant in the input gas exceeds a concentration of the contaminant in the treated gas.

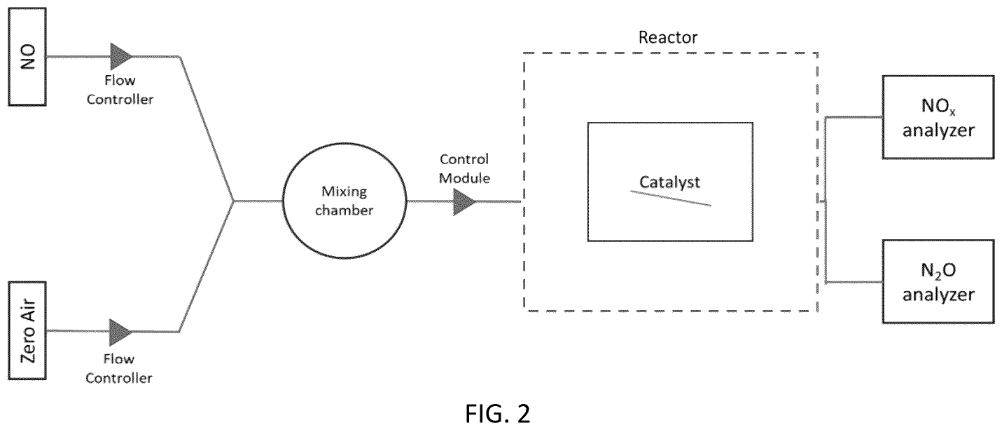

To evaluate the performance of the photocatalyst-coated optical fiber reactor relative to other known reactor designs, an experimental setup is designed to allow a range of conditions, as shown in FIG. 2. This system allows dilution of target gases from parts per billion (ppb) to percent and flow rates of 0.2 to 65 liters per minute (LPM), including the test conditions with gas concentrations of 600 ppb NOₓ using a range of flow rates at the order of 0.2 to 2 LPM. The setup supports a relative humidity range of 50 to 60%. A representative photocatalytic optical fiber reactor is tested for removal of nitrogen oxide.

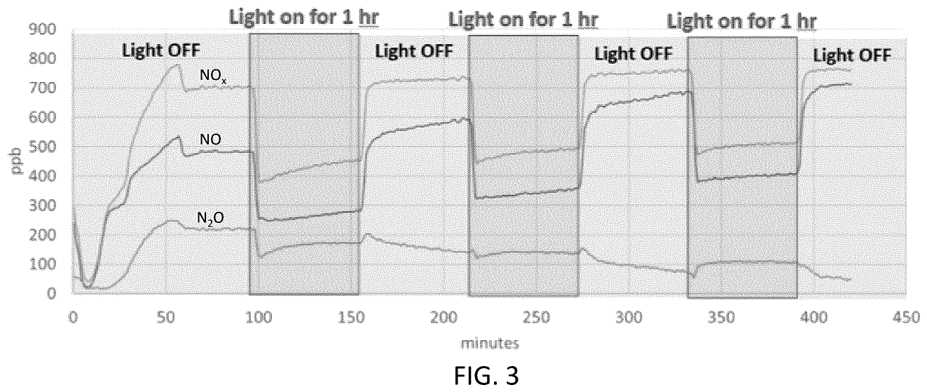

FIG. 3 shows representative results for removal of NOₓ and N₂O in air when irradiation was launched in the photocatalyst-coated optical fibers. This demonstration shows a greater than 40% NO removal with a residence time of less than 1 minute in the reactor. Increasing the length or number of fibers would allow for greater NO removal.

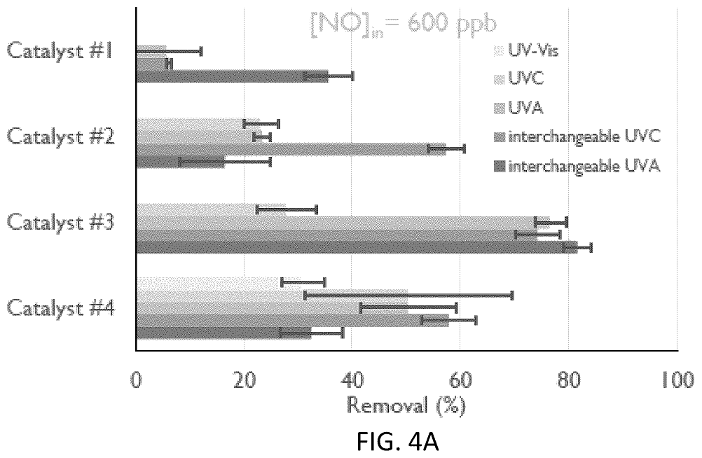

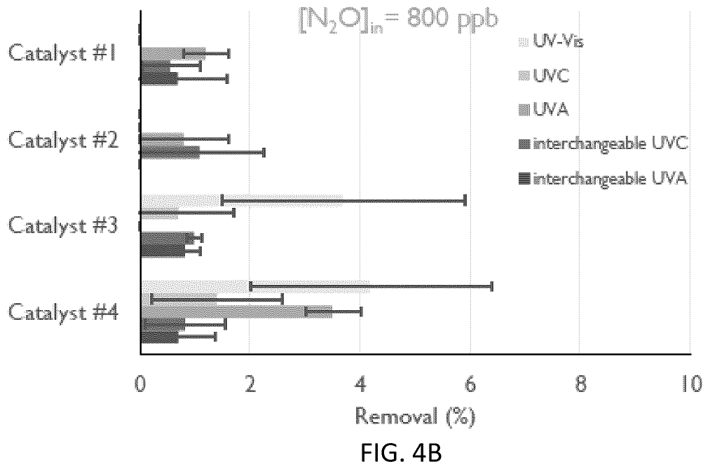

FIGS. 4A and 4B show results for photocatalyst and light source testing. The experiments test the photocatalytic removal achieved with four different photocatalysts using three different radiation sources. Photocatalyst #2 is obtained from Fotosan (Caspani Srl, Varese, Italy) and is a photocatalytic spray designed for use on specialty glass as a self-cleaning surface. Photocatalyst #3 is obtained from FN1 (FN Nano Inc., Reno, NV) and is a photocatalytic paint designed for self-cleaning surfaces and air remediation. Photocatalyst #4 is a TiO₂ coating prepared in the Aeroxide P25 laboratory (Evonik, Essen, Germany). The experiments are conducted by flowing either NO or N₂O through the reactor system shown in FIG. 2 at the desired concentration until steady state was achieved. The light source is then powered on and the photocatalyst is exposed to radiation for one hour. The concentrations of NOₓ and N₂O can be monitored.

Although the photocatalytic coating, irradiation wavelength, and gas phase contaminants have been described for removal of nitrogen oxides with TiO₂, optical fiber reactors describe herein can be used with other photocatalysts and irradiation wavelength(s) to treat other gas phase contaminants.

### EXAMPLES

Photocatalytic experiments were conducted using the experimental setup shown in FIG. 2. The experimental setup included a mass flow gas dilution system (Alicat Scientific, Tucson, Arizona) that allowed gas flows to be delivered to the reactor at varying concentrations and flow rates. Humidity was controlled during experiments and was monitored using a Govee hygrometer/thermometer (Shenzen, China). NO, NO₂ and N₂O concentrations were continuously monitored using the Thermo 42C NOₓ trace level chemiluminescence analyzer and the Thermo 46i gas filter correlation N₂O analyzer. NOₓ and N₂O concentrations were continuously logged using the Thermo iPort continuous data acquisition software.

### Fiber Optic Reactor

An experimental TiO₂ coated fiber optic reactor was designed to focus on increasing the total photocatalytic surface area by filling a reactor with coated fiber optics. The use of coated fiber optics allowed selection of the light source through tailored LEDs, which can lower energy used for the light source. The use of coated fiber optics also allowed uniform light exposure over the entire coated surface, which can increase photocatalytic removal.

To create the photocatalyst surface, a bundle of fiber optics was dip-coated with Aeroxide P25 TiO₂ (Essen, Germany). Coating was accomplished using a spray coating technique using a solvent (e.g., isopropyl alcohol) containing nanoparticles of the catalyst, designed to attach onto the polyvinylidene fluoride (PVDF) cladding of the optical fiber. UVA LEDs were used as the light source to expose the photocatalyst through the fiber optics. Filling a reactor with coated fiber optics can increase the total photocatalyst surface area without bulky packing material, which can increase pressure drops. Additionally, having the gas flow through the fiber optics decreased the total distance for NOₓ and N₂O to diffuse to the photocatalytic surface.

Initial testing showed that the application of UVA light decreased the levels of NOₓ, NO, and N₂O. However, heat generated from the light source melted the epoxy holding the fibers together. Subsequent designs incorporated a heat compatible epoxy and an optional cooling fan. In one example, a TiO₂-coated fiber reactor included 110 optical fibers. Each of the optical fibers had a total length of 27.5 cm, an outer diameter of 1.6 mm, and a surface area of 2543 cm². The volume of the reactor was 230 mL, and the surface area-to-volume ratio was 11.0 cm²/cm³. The JB WELD HighHeat epoxy was used to hold the fibers together.

### Photocatalyst Stability to Silane Exposure

Silane is used in the semiconductor industry, for example, in lithography. As such, the stability of the photocatalyst (TiO₂) upon exposure to silane was assessed. Three samples of TiO₂ coated optical fiber were exposed to 2% silane for 1 hour (sample 1) and 3 hours (samples 2 and 3). Scanning electron microscopy and X-ray photoelectron spectroscopy was used to characterize the exposed samples for photocatalytic removal and nitrate formation. The X-ray photoelectron spectroscopy spectra of the treated test samples indicated there was no significant increase in silicon on the surface of the photocatalyst. The scanning electron microscopy spectra also showed there was no significant increase in silicon on the surface of the photocatalyst. While the photocatalyst is removing NOₓ and NO₂, nitrate (NO₃⁻) forms on the surface through oxidation of NO and NO₂. The results of nitrate wash ion chromatography indicated silane exposure did not cause apparent catalyst poisoning.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An optical fiber reactor comprising:
a reaction chamber defining an inlet at a first end of the reaction chamber and an outlet at a second end of the reaction chamber, wherein the inlet is configured to receive an input gas comprising a contaminant and the outlet is configured to allow egress of a treated gas from the reaction chamber;
a multiplicity of side-emitting optical fibers extending from the first end of the reaction chamber toward the second end of the reaction chamber, wherein an exterior surface of each optical fiber of the multiplicity of side-emitting optical fibers is coated with a photocatalyst; and
a light source optically coupled to the multiplicity of side-emitting optical fibers and configured to irradiate, with light of a selected wavelength, the photocatalyst on the multiplicity of side-emitting optical fibers from an interior of each of the optical fibers, and wherein the photocatalyst is configured to reduce a concentration of the contaminant in the reaction chamber through oxidation or reduction of the contaminant.

2. The optical fiber reactor of claim 1, wherein the reaction chamber is cylindrical.

3. The optical fiber reactor of claim 1, wherein the multiplicity of side-emitting optical fibers comprises glass or plastic.

4. The optical fiber reactor of claim 3, wherein the plastic comprises polymethyl methacrylate (PMMA) or polyvinylidene fluoride (PVDF).

5. The optical fiber reactor of claim 1, wherein the multiplicity of side-emitting optical fibers comprises 10 to 1000 optical fibers.

6. The optical fiber reactor of claim 1, wherein the photocatalyst comprises TiO₂.

7. The optical fiber reactor of claim 1, wherein the light source comprises one or more light-emitting diodes or organic light-emitting diodes.

8. The optical fiber reactor of claim 1, wherein the light source is configured to emit ultraviolet radiation.

9. The optical fiber reactor of claim 8, wherein the ultraviolet radiation comprises UVA, UVC, or both.

10. The optical fiber reactor of claim 1, wherein the selected wavelength is 365 nm.

11. The optical fiber reactor of claim 1, further comprising a fan coupled to the reaction chamber to cool the multiplicity of side-emitting optical fibers.

12. A method of reducing a concentration of a contaminant in an input gas, the method comprising:
flowing the input gas comprising the contaminant into a first end of a reaction chamber comprising a multiplicity of side-emitting optical fibers, wherein an exterior surface of each optical fiber of the multiplicity of side-emitting optical fibers is coated with a photocatalyst;
irradiating a first end of each of the multiplicity of the side-emitting optical fibers with light, thereby providing the light along a length of an interior of each of the side-emitting optical fibers and exciting the photocatalyst;
photocatalytically oxidizing or reducing the contaminant, thereby reducing a concentration of the contaminant in the reaction chamber to yield a treated gas; and
flowing the treated gas out of a second end the reaction chamber, wherein a concentration of the contaminant in the input gas exceeds a concentration of the contaminant in the treated gas.

13. The method of claim 12, wherein flowing the input gas into the first end of the reaction chamber comprises flowing the input gas along a length of the side-emitting optical fibers from the first end to the second end.

14. The method of claim 12, wherein the contaminant comprises a nitrogen oxide.

15. The method of claim 14, wherein the nitrogen oxide comprises NO, NO₂, N₂O, or any combination thereof.

16. The method of claim 12, wherein the photocatalyst comprises TiO₂.

17. The method of claim 12, wherein the light comprises UVA light.

18. The method of claim 17, wherein a wavelength of the light is 365 nm.

19. The method of claim 12, wherein flowing the input gas into the first end of the reaction chamber and flowing the treated gas out of the second end of the reaction chamber occurs simultaneously.

20. The method of claim 12, wherein irradiating the first end of each of the multiplicity of the side-emitting optical fibers occurs continuously.
